(19) United States
(12) Patent Application Publication
(10) Pub. No.: US 2015/0165616 A1
(43) Pub. Date: Jun. 18, 2015

(54) HOLDING UNIT FOR SOCKETS

(71) Applicant: Shwu-Ruu Chern, Taichung (TW)

(72) Inventor: Shwu-Ruu Chern, Taichung (TW)

(21) Appl. No.: 14/132,042

(22) Filed: Dec. 18, 2013

(51) Int. Cl. B25H 3/00; B25B 23/08

(52) U.S. Cl. CPC B25H 3/006; B25B 23/08

(57) ABSTRACT

A holding unit includes at least one recess defined in a first side thereof and extension extends from the first side of the holding unit. A curved finger recess is defined in a face of the extension and communicates with the lower inner end of the recess. A protrusion extends from the top inner end of the recess. Two notches are defined between two sides of the protrusion and two lateral insides of the recess. The protrusion has an inclined face defined between the two sides and the distal end thereof. A socket is positioned in the recess and the protrusion is engaged with the mounting hole of the socket, and the wall of the socket is received in the two notches. The socket is well positioned in the recess. The inclined face guides the socket to be removed from the recess.

### BACKGROUND OF THE INVENTION

1. Fields of the Invention

The present invention relates to a holding unit, and more particularly, to a holding unit for holding sockets.

2. Descriptions of Related Art

The conventional tool box includes multiple recesses for receiving sockets, however, there are multiple different sizes of the sockets and most of the sockets are not well held in the recesses so that noise is generated when the sockets hits the inside wall of the recesses in the tool box. When open the tool box, the sockets may drop from the recesses.

The present invention intends to provide a holding unit for holding the sockets so as to improve the shortcomings mentioned above.

### SUMMARY OF THE INVENTION

The present invention relates to a holding unit and comprises at least one recess defined in the first side thereof and an extension extends from the first side of the holding unit. At least one curved finger recess is defined in the top face of the extension and communicates with the lower inner end of the at least one recess. A protrusion extends from the top inner end of the at least one recess and is located corresponding to the at least one curved finger recess. Two notches are respectively defined between two sides of the protrusion and two lateral insides of the at least one recess.

Preferably, the at least one recess is a semi-circular recess.

Preferably, the protrusion has an inclined face defined between the two sides and the distal end thereof.

Preferably, the inclined face is tapered inclinedly and upward from the front-lower edge of the distal end toward the second side of the holding unit.

The primary object of the present invention is to provide a holding unit for holding the sockets which are well positioned and does not shake to generate noise.

Another object of the present invention is to provide a holding unit for holding the sockets which are easily removed from the recesses of the holding unit.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the holding unit of the present invention;

FIG. 2 is another exploded view of the holding unit of the present invention;

FIG. 3 is a perspective view to show the holding unit of the present invention;

FIG. 4 is a cross sectional view of the holding unit of the present invention;

FIG. 5 is another cross sectional view of the holding unit of the present invention;

FIG. 6 is yet another cross sectional view of the holding unit of the present invention;

FIGS. 7 to 9 show the steps for removing the socket from the holding unit of the present invention, and

FIG. 10 shows that the holding units of the present invention are installed in a tool box.

### DETAILED DESCRIPTION OF THE PREFERRED EMBODIMENT

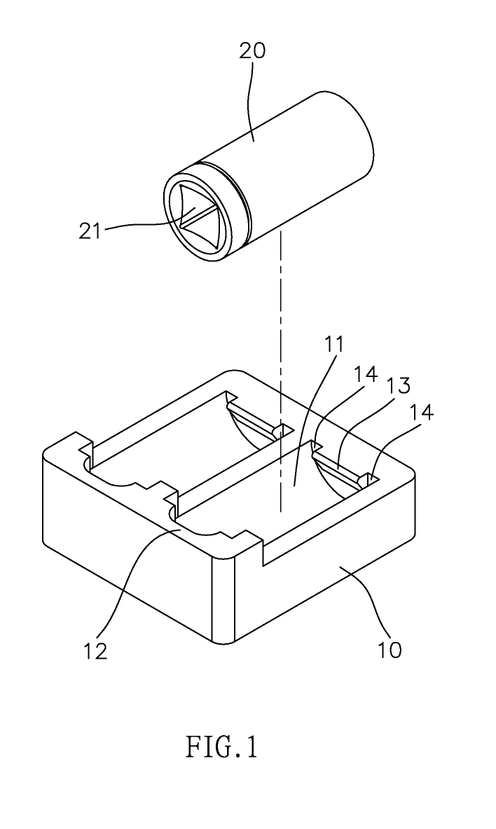

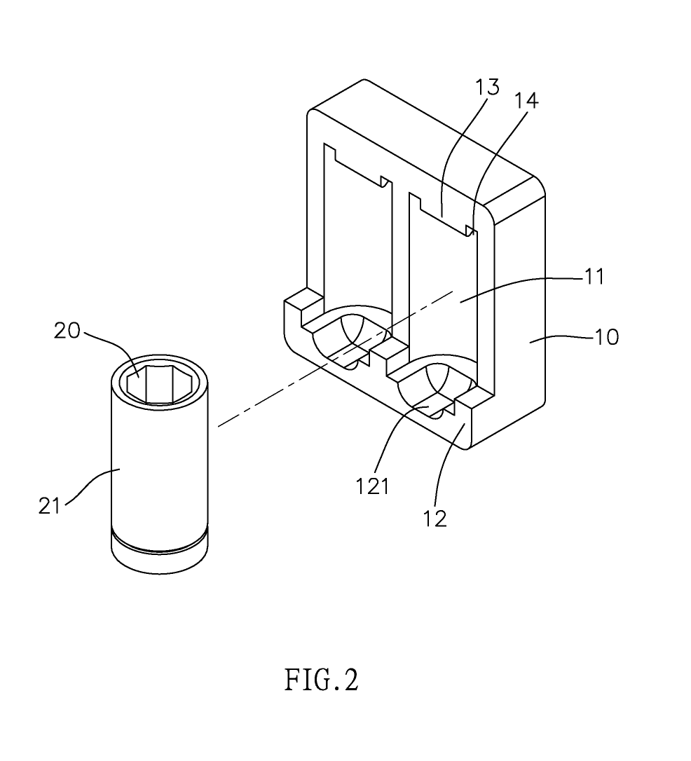

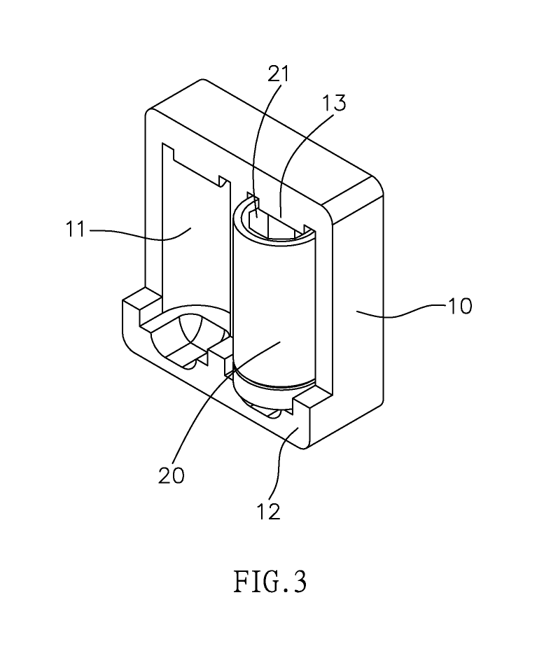

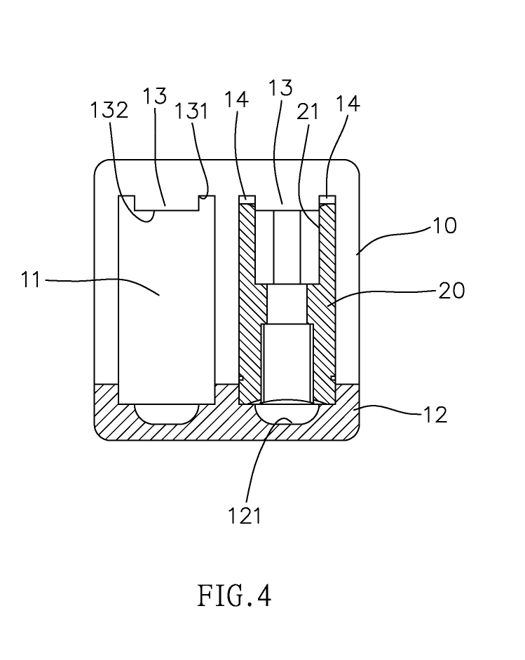

Referring to FIGS. 1 to 10, the holding unit 10 of the present invention comprises at least one recess 11 defined in the first side thereof and an extension 12 extends from the first side of the holding unit 10. At least one curved finger recess 121 is defined in the top face of the extension 12 and communicates with the lower inner end of the at least one recess 11. A protrusion 13 extends from the top inner end of the at least one recess 11 and is located corresponding to the at least one curved finger recess 121. Two notches 14 are respectively defined between two sides of the protrusion 13 and two lateral insides of the at least one recess 11. The at least one recess 11 is a semi-circular recess. The socket 20 is received in the recess 11 and the protrusion 13 is engaged with the mounting hole 21 of the socket 20. The wall around the mounting hole 21 of the socket 20 is engaged with the two notches 14 so that the socket 20 is well held by the holding unit 10.

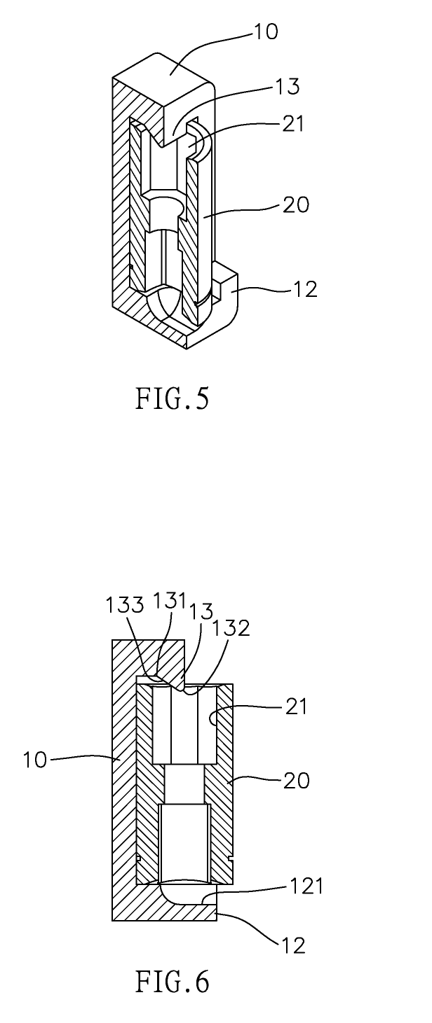

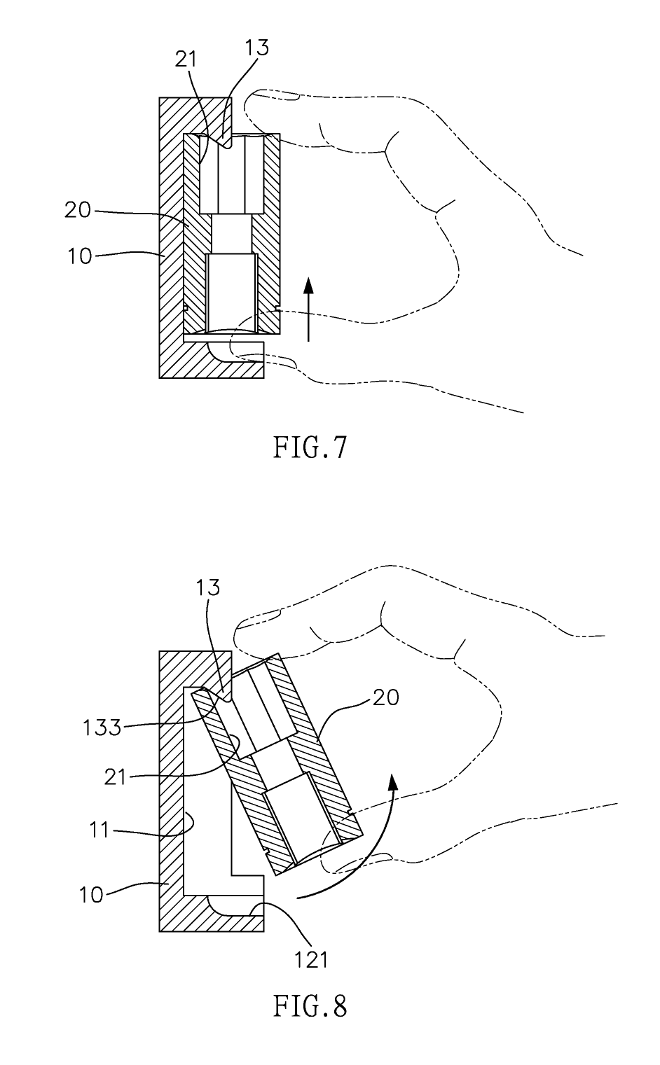

The protrusion 13 has an inclined face 133 defined between the two sides 131 and the distal end 132 thereof. In detail, the inclined face 133 is tapered inclinedly and upward from the front-lower edge of the distal end 132 toward a second side of the holding unit 10 as shown in FIGS. 5 and 6.

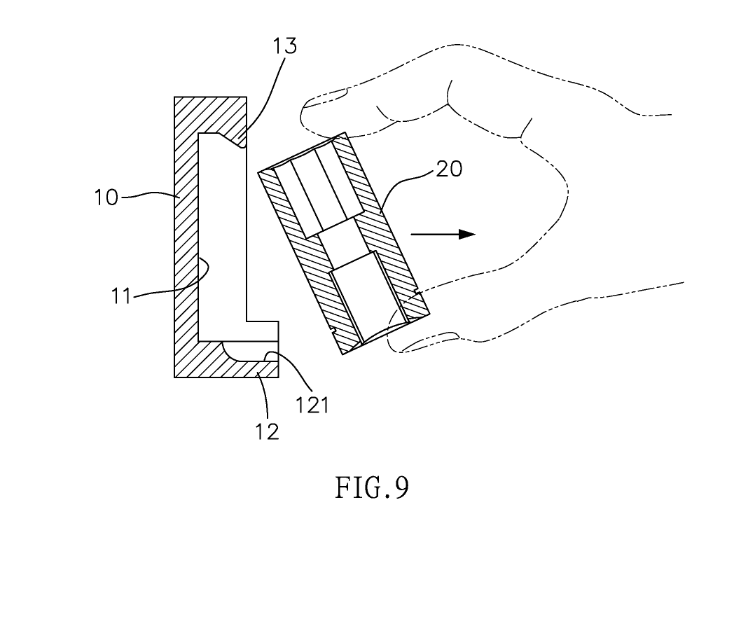

When the socket 20 is to be removed from the holding unit 10, the user uses the thumb and index finger hold the socket 20, and lifts the socket 20 toward the protrusion 13 as shown in FIG. 7. The thumb is then inserted into the curved finger recess 121 and pivots the socket 20 outward about the protrusion 13 as shown in FIG. 8. The inclined face 133 guides the removal of the socket 20 as shown in FIG. 9.

When the socket 20 to be put back to the holding unit 10, the steps mentioned above are proceeded in reverse sequences, the socket 20 is tilt and the protrusion 13 is inserted into the mounting hole 21. The socket 20 is then pushed into the recess 11. The protrusion 13 holds the socket 20 so that the socket 20 does not shake and no noise is generated. The socket 20 is well positioned and does not drop from the recess 11.

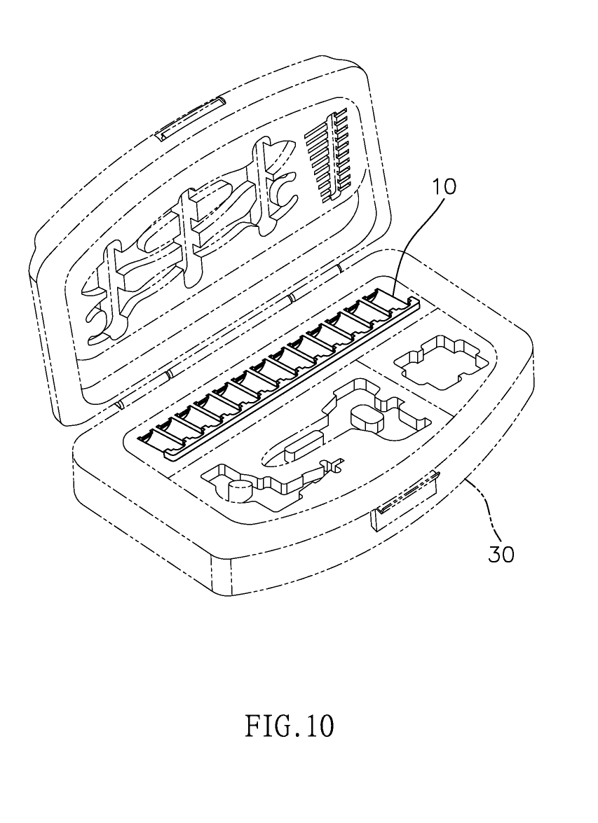

Multiple holding units 10 of the present invention can be made integrally and installed to the inside of the hand tool 30 as shown in FIG. 10 to hold the sockets 20 of different sizes.

While we have shown and described the embodiment in accordance with the present invention, it should be clear to those skilled in the art that further embodiments may be made without departing from the scope of the present invention.

What is claimed is:

1. A holding unit comprising:
at least one recess defined in a first side thereof and an extension extending from the first side of the holding unit, at least one curved finger recess defined in a face of the extension and communicating with a lower inner end of the at least one recess, a protrusion extending from a top inner end of the at least one recess and located corresponding to the at least one curved finger recess, two notches defined between two sides of the protrusion and two lateral insides of the at least one recess.

2. The holding unit as claimed in claim 1, wherein the at least one recess is a semi-circular recess.

3. The holding unit as claimed in claim 2, wherein the protrusion has an inclined face defined between the two sides and a distal end thereof.

4. The holding unit as claimed in claim 3, wherein the inclined face is tapered inclinedly and upward from a front-lower edge of the distal end toward a second side of the holding unit.
